(19) United States
(12) Patent Application Publication
(10) Pub. No.: US 2017/0200225 A1
(43) Pub. Date: Jul. 13, 2017

(54) Secure Customer Key Injection for Build-to-Stock Systems

(71) Applicant: Itron, Inc., Liberty Lake, WA (US)

(72) Inventor: Rajesh Kanungo, San Jose, CA (US)

(21) Appl. No.: 15/144,048

(22) Filed: May 2, 2016

Related U.S. Application Data
(60) Provisional application No. 62/278,311, filed on Jan. 13, 2016.

(51) Int. Cl. G06Q 40/04; H04L 9/08; H04L 9/32; H04L 9/14; H04L 9/30

(52) U.S. Cl. CPC G06Q 40/04; H04L 9/14; H04L 9/30; H04L 9/3247; H04L 9/0861; G06Q 2220/00

(57) ABSTRACT

Techniques for manufacturing cryptographically-enabled network endpoints are described herein. In an example, an endpoint is provisioned with keys, which may include a revocation key, a command key, a recovery key and other cryptographic information. A buyer of the endpoint may send one or more keys to the manufacturer, and request that a handover package be sent by the manufacturer to the buyer. The manufacturer sends the handover package, which may include cryptographic information appropriately signed by the manufacturer. Upon receipt, the handover package is cryptographically processed by the buyer and portions are included in a takeover package sent to the endpoint. The endpoint may replace operational keys within the endpoint and switch its operation from use of manufacturer-produced credentials to use of buyer-produced credentials. Accordingly, the endpoint is provisioned for secure operation by the owner in an advanced metering infrastructure (AMI) or Internet of Things environment.

### RELATED APPLICATIONS

This patent application claims priority to U.S. provisional patent application Ser. No. 62/278,311, titled “Secure Customer Key Injection for Build to Stock Systems,” filed on 13 Jan. 2016, commonly assigned herewith, and hereby incorporated by reference.

### BACKGROUND

In the context of an advanced metering infrastructure (AMI) or other Internet-of-Things (IoT) scenario, network endpoints may encrypt data, decrypt commands, and otherwise protect assets using cryptography. The manufacture of such endpoints, such as electric, gas and water meters, can be problematic because the endpoints may have multiple keys that are associated with cryptographically controlled functions. A metering device may have a plurality of command, recovery, revocation and/or public/private keys and key pairs, along with a serial number. While the endpoint is held in stock, waiting for a buyer, opportunities may exist to tamper with the keys. In a safer alternative, such endpoints may be “built to order,” thereby reducing opportunities for the keys to be tampered with. When an endpoint is built to order, keys associated with the buyer of the endpoint are injected into the endpoint during manufacturing. In a build-to-order circumstance, customer information is required before manufacturing. Thus, while build-to-stock is more convenient, it is riskier; and while build-to-order is safer, it is logistically more expensive.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components. Moreover, the figures are intended to illustrate general concepts, and not to indicate required and/or necessary elements.

FIG. 1 is a sequence diagram showing an example relationship between a key generator of a manufacturer, a network endpoint, an endpoint reseller and a security manager of an endpoint buyer, and showing techniques for build-to-stock construction of endpoints consistent with an advanced metering infrastructure (AMI) or with the Internet-of-Things (IoT).

FIG. 2 is a block diagram showing example detail of creation of a handover package, performed at the key generator of the manufacturer and sent to the security manager of the utility company or other buyer.

FIG. 3 is a block diagram showing example detail of creation of an operational key bundle, which may be performed by the buyer.

FIG. 4 is a block diagram showing example detail of creation of a takeover package, performed at the buyer and sent to the endpoint.

FIG. 5 is a block diagram showing an example verification at an endpoint of the signature on the takeover package, and example extraction of the utility revocation key.

FIG. 6 is a block diagram showing example verification of the takeover package performed at the endpoint.

FIG. 7 is a block diagram showing example extraction of the operational keys, performed at the endpoint.

FIG. 8 is a block diagram showing example structure of a manufacturer of endpoints, a buyer of endpoints, and the endpoint.

FIG. 9 is a flow diagram showing an example method of endpoint construction consistent with build-to-stock requirements, for application to an advanced metering infrastructure (AMI) or the Internet of Things.

### DETAILED DESCRIPTION

### Overview

The specification describes techniques for manufacturing and transferring ownership of cryptographically enabled network devices. The network devices may be part of the Internet of Things (IoT). In particular examples, the network devices may be related to a particular industry or network type, such as an advanced metering infrastructure (AMI), a smart grid, and smart meters, etc.

In an Internet-of-Things environment, an AMI environment, or other context, network devices are often constructed in a build-to-order manner. According to conventional build-to-order techniques, a buyer of such network devices may provide cryptographic information to the manufacturer, so that the information can be injected into the network device(s), thereby readying them for control by the buyer. This transfer by the buyer may also provide an opportunity for bad actors (perhaps working for the manufacturer), to copy or replace the keys. In most instances, such a build-to-order environment—by nature a series of distinct and customized production runs—is more expensive than build-to-stock.

In contrast, constructing devices in a build-to-stock manner presents inherent risks that devices, while carried in stock and a buyer is not yet identified, will be compromised. Keys, commands, certificates and other data may be copied, and control over the devices may become shared with bad actors after the buyer takes delivery of the device(s). In an IoT environment, the bad actors may cause money transfers, information theft, camera and/or microphone control, or even physical damage in the event of driverless cars and drones. In an AMI environment, utility (electricity, gas, water, etc.) consumption data may be altered, utility theft may be enabled, and/or the utility service may be controlled (e.g., turned off) by the bad actors. Accordingly, while build-to-stock has significant economic incentives, serious security issues are also present.

To overcome the significant problems associated with build-to-stock, new cryptographic techniques and device-manufacturing techniques may be employed. In one example, an endpoint such as a smart meter is provisioned with a revocation key, a command key, a recovery key and/or other cryptographic information and certificates, as appropriate. The endpoint may be warehoused or sent to a third-party reseller. Upon purchase, a utility company or other buyer may send one or more keys to the manufacturer, and request that a handover package be sent by the manufacturer to the buyer. In response, the manufacturer sends the handover package, which may include cryptographic information appropriately signed by the manufacturer. Upon receipt, the handover package is cryptographically processed by the buyer and included in a takeover package sent to the endpoint. The endpoint may perform additional cryptographic processing, which may replace the operational keys within the endpoint and switch its operation from use of manufacturing device credentials to use of utility company (or other buyer) device credentials. Accordingly, the endpoint is provisioned for secure operation by the utility or other buyer and/or owner in an AMI or IoT environment.

In some versions of the invention, a meter recovery key, also known as a meter recovery public/private key-pair, is simply defined as the meter public/private key pair. In some versions of the invention, a utility revocation key, also known as a utility revocation public/private key-pair, is simply defined as a utility key or utility public/private key-pair.

Examples of the techniques described herein relate to the safe operation of devices in a network, such as the Internet or a smart grid. Accordingly, the techniques resolve many smart meter, device, device-manufacture, Internet-centric and utility smart grid-centric problems. Such problems, addressed by the techniques described herein, are present in both the AMI and the IoT environments. The solutions to such problems are necessarily rooted in general-purpose computer, limited-purpose device and network-based technologies. Moreover, such solutions result in safer and more functional operation of networks and network-connected devices. And further, the disclosed techniques provide enhancements to encryption technology in a build-to-stock manufacturing environment that results in construction of safer- and better-functioning networked devices, and control over such devices by other networked devices. Significant techniques are introduced herein, such as sequences of communication that go beyond data transfer and command and/or response transmissions to actually change the functionality of network devices. Moreover, significant structures are introduced herein, such as a handover package and a takeover package. Together, these techniques and structures go beyond data transfer and processing, to result in better and safer manufacture and operation of networks and networked components. Moreover, the build-to-stock techniques introduced herein save significant resources. In particular, the process by which endpoints are manufactured is more efficient if it does not have to stop and go, according to sales made by the manufacturer. That is, by creating endpoints at a uniform rate, stocking them until sold, and then provisioning them cryptographically according to the techniques describe herein, significant reduction in manufacturing costs result. Such an efficient and uniform manufacturing rate, and such high security levels in a build-to-stock environment, would not be possible without the techniques described herein, due to the inherent risks of cryptographic key and certificate compromise associated with leaving endpoints in a warehouse environment.

### Example Build-to-Stock System

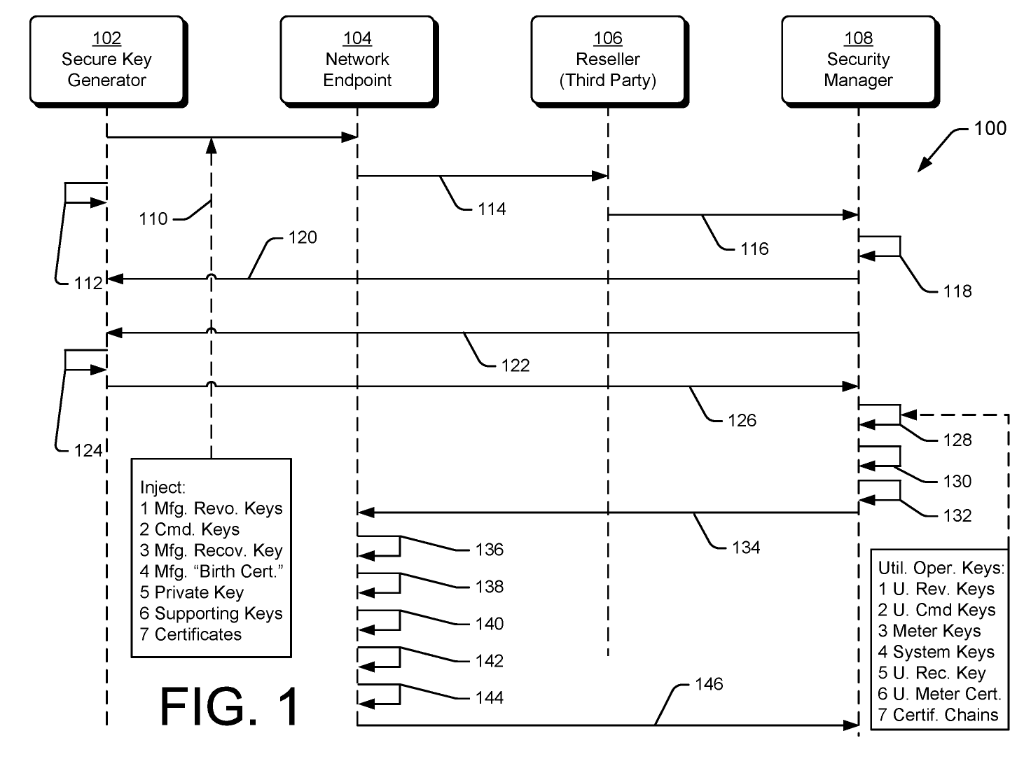

FIG. 1 shows an example environment 100 between a key generator 102, a network endpoint 104, a reseller 106 and a security manager 108. The environment 100 also shows techniques for construction of smart meters consistent with an advanced metering infrastructure. However, the same or similar techniques may be used to manufacture or operate any endpoint in a networked environment consistent with the Internet-of-Things (IoT).

In the example, the key generator 102 may be part of an endpoint manufacturer, such as a manufacturer of smart meters for an electrical grid. The network endpoint 104 may be a smart meter, smart sensor, transformer, router, relay, data collector, or other network device that is under construction. The reseller 106 may be a vendor, warehouse or other third-party company (other than the end user). In some examples, the reseller is a particular security risk, in that time spent by product at the reseller provides opportunities for encryption data (e.g., keys) to be copied, removed, replaced, stolen, etc. Some opportunities may also exist at the manufacturer, particularly if the manufacturer is engaged in build-to-stock, and then warehouses the product. Stolen keys may be used later by bad actors, such as to change utility consumption information. In an IoT environment, the stolen keys may be used for a wide array of illegal purposes. The security manager 108 may be software, server(s) upon which the software is running, or a utility company. The utility company is typically the buyer or end user of the network endpoint 104.

At operation 110, the manufacturer (e.g., using the secure key generator 102) injects cryptographic materials into an endpoint 104. The cryptographic materials may be based on the manufacturer's build-to-stock credentials. In one example, the cryptographic materials injected into the meter may include: (1) a public key of the manufacturer; (2) a revocation key of the manufacturer; (3) one or more command keys; (4) a recovery key of the manufacturer; (5) a “birth certificate” containing information about the endpoint and provided by the manufacturer; (6) a private key, or more typically a public/private key pair; (7) other supporting keys, as indicated by the intended use of the endpoint 104; and/or (8) supporting certificates, also as indicated.

At operation 112, the manufacturer 102 stores the cryptographic materials that were injected into the endpoint 104. The materials may be stored according to a serial number or other identifier of the endpoint 104.

At operation 114, the endpoint is sold and transferred to a third party reseller 106, or is moved to a storage facility at the manufacturer. During the time which the endpoint is stored, it is possible that the cryptographic information injected at operation 110 may be altered or copied by bad actors. Subsequent operations overcome this issue.

At operation 116, the endpoint is sold and transferred to a customer. As noted above, this sale and transfer may or may not be performed using the third party reseller 106. In the example shown, a smart meter is sold to a utility company.

At operation 118, the security manager 108 or similar software is executed to acknowledge, receive and setup for the incoming smart meter or other endpoint 104. In an example, a smart meter is examined, its serial number or other identifier is read or otherwise obtained, and records of the meter are recorded.

At operation 120, the utility company (e.g., by operating the security manager 108) contacts the manufacturer (e.g., through a tool of the manufacturer, such as the secure key generator 102). At the utility, the security manager 108 is setup to accommodate the endpoint; transfer keys are exchanged with the manufacturer; and revocation keys and command keys generated by the utility are determined and/or recorded. In a further example of the communication sent by the utility, when a utility buys a meter or other endpoint, it provides the serial number and optionally the public key of the endpoint to the manufacturer in a secure manner.

At operation 122, the security manager 108 or other tool of the utility company operates to contact the secure key generator 102 or other tool of the manufacturer and to request a handover package related to the purchased smart meter or other endpoint 104. The utility may provide the serial number(s) of the meters purchased, and optionally the public key of the meter. This communication may be performed using a secure key transfer file (SKTF), which may be signed by a transfer key of utility.

At operation 124, the secure key generator 102 or other tool of the manufacturer creates a handover package for transmission to the utility. The handover package may include one or more of: the revocation key sent by the utility at operation 120; the serial number of the endpoint; and/or a meter recovery public key of the manufacturer. This information may be signed using a revocation private key of the manufacturer. In a specific example, a manufacturer creates a handover package with the public key of the utility and the serial number of the endpoint, and signs the handover package with the private key of the manufacturer that corresponds to the manufacturer public key in the meter, and specifies that the public key of the utility should be used to verify any takeover request.

At operation 126, the manufacturer sends the signed handover package to the utility, such as by operation of a secure key transfer file, which may be signed by a transfer key of the manufacturer.

At operation 128, the utility creates a new key bundle with new utility operational keys. The new key bundle will replace existing keys in the endpoint 104, thereby nullifying any possible efforts, made by bad actors, to copy or change keys within the endpoint. The new key bundle may be considered to be an operational key bundle, and may include several utility operational keys. In the example shown, the keys include: (1) utility revocation key(s); (2) utility command key(s); (3) meter key(s); (4) system key(s); (5) utility recovery key(s); (6) utility meter certificate(s); and (7) certificate chain(s).

At operation 130, the new key bundle is encrypted with the endpoint recovery public key of the manufacturer. In an example, the key was obtained by the utility from the handover package sent by the manufacturer.

At operation 132, a takeover package is created for transmission to the endpoint. The takeover package may include the encrypted key bundle from operation 130 and the handover package received by the utility at operation 126. The takeover package may be signed using a revocation private key of the utility. In a specific example, the utility generates and appends its own replacement keys to the handover package, thereby creating a takeover package, and signs the takeover package with the private key of the utility.

At operation 134, the takeover package is sent to the endpoint. The transmission may be made via FDM, meter shop OTA.

Operations 136-144 may be performed at the endpoint 104. At operation 136, the signature on the handover package is verified with a revocation key of the manufacturer stored at the endpoint. At operation 138, the signature of the takeover package is verified using the public key of the utility from the handover package. In a specific example of operations 136 and 138, an endpoint verifies the handover package using the public key of the manufacturer that was injected into the endpoint at operation 110. The endpoint then uses the public key of the utility in the handover package to verify the signature on the whole takeover package. At operation 140, the key bundle is decrypted with the recovery key of the manufacturer. At operation 142, the operation keys and credentials of the utility are stored to get operational device credentials. In a specific example, the endpoint extracts all of the replacement keys in the takeover package and injects them into the endpoint. At operation 144, the endpoint switches from use of device credentials of the manufacturer to use of device credentials of the utility company or other buyer. Accordingly, the device is now using keys and other secure data provided by the utility. This provides security and confidence to the utility, and relieves the manufacturer of uncertainty and liability. At operation 146, the endpoint sends a confirmation or acknowledgement message to the utility, indicating that the switch of credentials is complete. The confirmation message indicates that manufacturer-provided keys and credentials are no longer being used and that buyer-provided keys and credentials are being used. In a specific example, the endpoint acknowledges the injection of operation 142 with a signature using the new endpoint private key on the old meter public key, the utility key and optionally other cryptographic material, such as a hash of any symmetric keys in the key bundle (from operation 128).

Variations of the environment 100 are possible. In a first variation, the endpoint (e.g., smart utility meter) may be able to generate its own public/private key pair. Endpoints in this circumstance may have substantial processing power, memory and electrical power. If possible, such internal key generation may result in greater security. The endpoint device can send the buyer the new meter public key signed by the original meter public key. In a second variation, symmetric keys can use Diffie Helman key exchange with the sending of actual secrets. Operation 146 can be used to send the information to the utility. In a third variation, certificates owned by the endpoint can have the certificate signing request (CSR) generated on the endpoint and sent to the buyer in a form that is signed by the original meter private key. The utility certificate authority (CA) can verify the signature and then generate a full certificate using its CA. The certificate can then be injected into the endpoint.

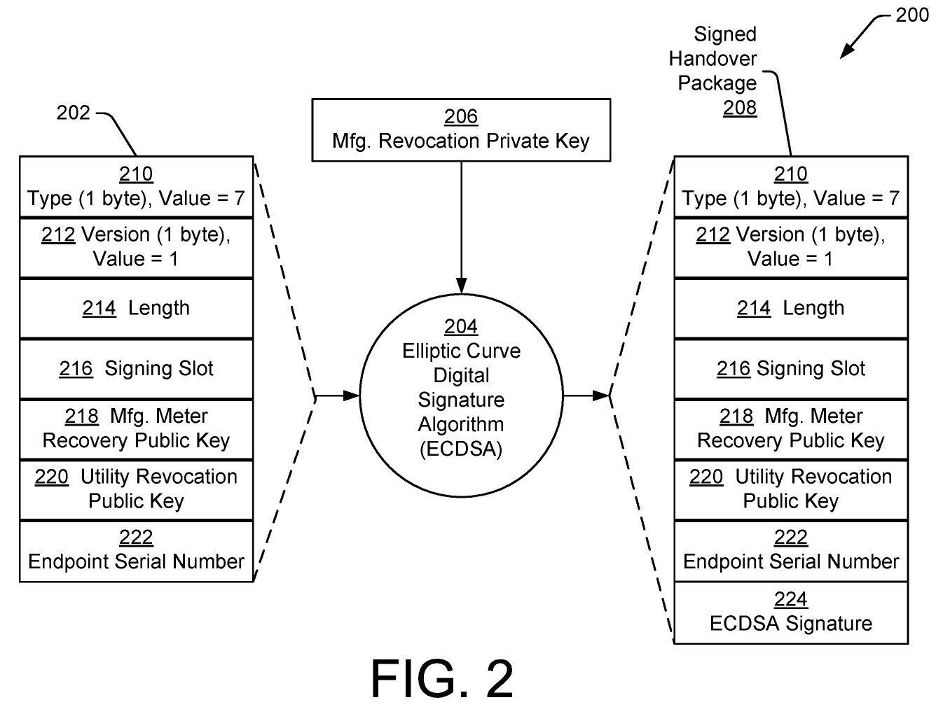

FIG. 2 shows an example of techniques 200 used in the creation of a handover package. The techniques 200 may be an expansion of, or alternative variation of, the techniques of operation 124 in FIG. 1. The handover package 208 is used by the manufacturer to hand over control of an endpoint to a security manager (or other control software) of a utility or other buyer. On receipt of a secure key transfer file, the secure key generator of the manufacturer creates a handover package for endpoints associated with each of the serial numbers for which the utility/buyer is requesting control. In one example, the handover package may be created by a signature over data including the concatenation of: the type; the version number; the signing slot number of the revocation private key of the manufacturer; the endpoint serial number; the recovery public key of the manufacturer; and/or the revocation public key of the buyer. Point compression may be used for elliptic curve cryptograph values.

The techniques 200 show creation of a handover package, which may be performed by the secure key generator 102 or other tool available to the manufacturer of the endpoint 104. The handover package is provided to the utility, and provides information that assists in the creation of the takeover package. The takeover package, provided by the utility/buyer to the meter/endpoint assists the endpoint in the switch from credentials provided by the manufacturer to credentials provided by the utility.

In example operation of the techniques 200, an unsigned handover package 202 is signed by operation of an elliptic curve digital signature algorithm (ECDSA) 204, having input of a revocation private key 206 of the manufacturer, to produce a signed handover package 208. While ECDSA techniques are described, other cryptographic technologies could be utilized. In the example shown, the unsigned handover package 202 includes data associated with package type 210, package version 212 and package length 214. A signing slot 216 may be provided. In the example, a recovery public key 218 of the manufacturer and a revocation public key 220 of the utility (or other customer) are provided. The endpoint (or utility meter) serial number 222 is provided. The signed handover package 208 includes substantially the same information, with the addition of an ECDSA signature 224.

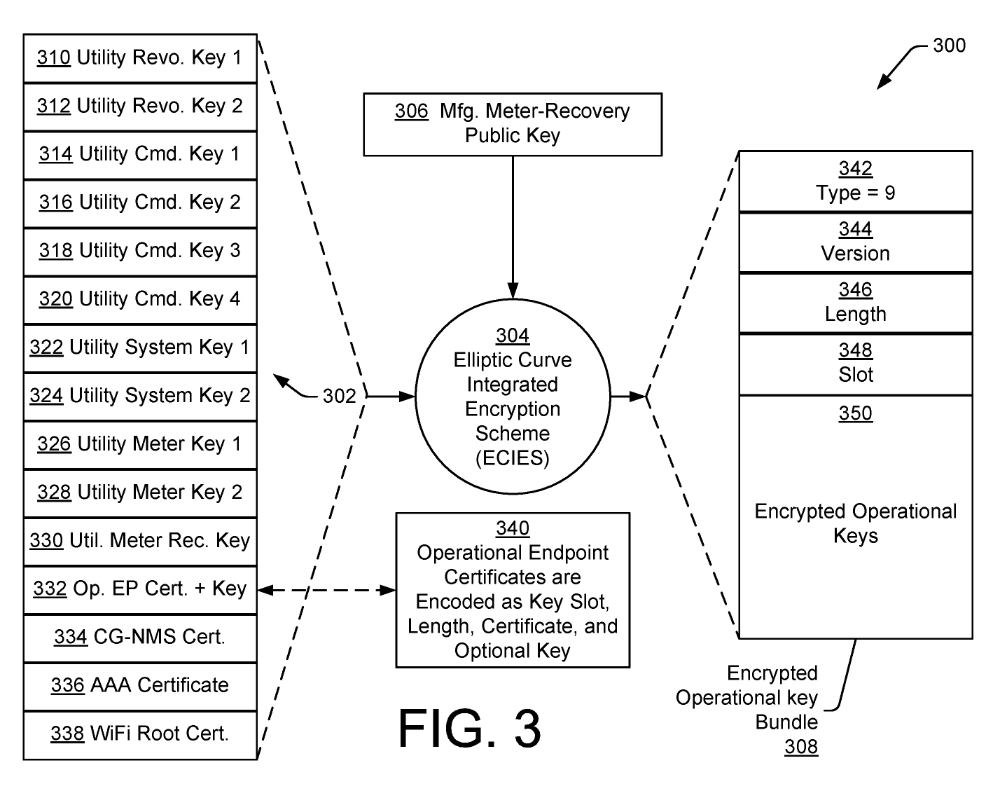

FIG. 3 shows an example of techniques 300 used in the creation and encrypting of an operational key bundle. The techniques 300 may be an expansion of, or alternative variation of, the techniques of operations 128 and/or 130 in FIG. 1. As an overview, upon receipt of the handover package from the secure key generator of the manufacturer, the security manager of the buyer verifies the signature, decrypts the payload and extracts the handover package. The security manager of the buyer then creates and encrypts an operational key bundle that provides keys needed for injection into the endpoint, which are sent to the endpoint in the takeover package.

In the example of FIG. 3, bundled keys 302 provided by the utility/buyer are encrypted, such as by use of an encryption scheme 304 and a meter recovery public key of the manufacturer 306, to create the encrypted operational key bundle 308. The techniques 300 may be performed at the security manager 108 or other tool available to the utility or other buyer of the endpoint 104. Thus, the techniques 300 operate at facilities of the utility/buyer to bundle and encrypt keys and other data for use in the construction of the takeover package. This provides the buyer with assurances that the endpoint will operate without compromise.

In example operation of the techniques 300, keys and data 302 should be selected according to the needs of the endpoint. The keys and data 302 may include a plurality of keys 310-332 that are provided by, and known only to, the utility. The keys 310-332 may include a mixture of revocation keys, command keys, system keys, meter keys, recovery keys and/or other keys as indicated. Various certificates 332-338 may also be included, based on needs of the endpoint. Optionally, a format or procedure 340 may be imposed on the operational endpoint certificates, thereby encoding them according to key slot, length, certificate and an optional key.

Operation of the elliptic curve integrated encryption scheme (ECIES) 304 using the meter or endpoint recovery public key 306 of the manufacturer creates the encrypted operational key bundle 308. The encrypted operational key bundle 308 may include formatting information or metadata such as type 342, version 344, length 346 and slot 348. The encrypted operational keys 350 comprise a bundle of keys consistent with those required by the endpoint having security characteristics that are under the control of the buyer/utility.

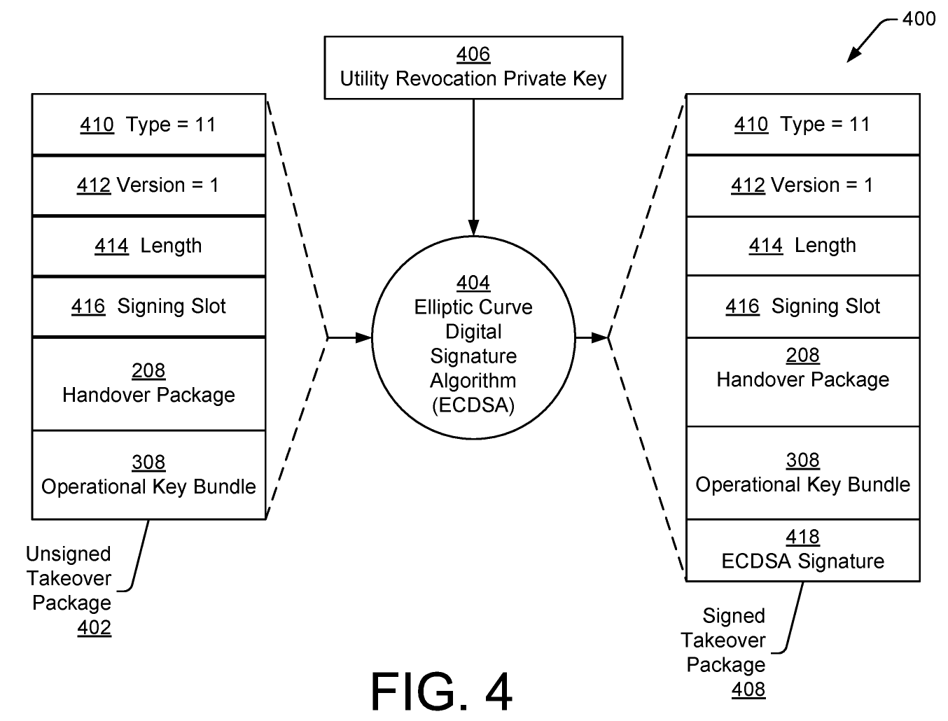

FIG. 4 shows example detail of techniques 400 used in the creation of a signed takeover package. The techniques 400 are an expansion of, or alternative variation of, the techniques of operation 132 in FIG. 1. In example operation of the techniques 400, an unsigned takeover package 402 is signed by operation of an elliptic curve digital signature algorithm (ECDSA) 404, having input of a revocation private key 406 of the utility, to produce a signed takeover package 408.

In an example, the signed takeover package is transmitted to the endpoint with which it is associated. Since the takeover package is signed and the keys inside it are encrypted, a secure mechanism to communicate the takeover package to the endpoint is not mandatory. However, one or more standard mechanisms may be used, such as RF, (e.g., over-the-air, NGC, fourth generation long-term evolution (4GLTE), radio frequency (RF) mesh, etc., frequency division multiplexing (FDM), WiFi, optical port, etc.). At the endpoint, the signed handover package is verified and keys and other data are extracted.

When the endpoint receives a takeover package, it has no prior knowledge of the buyer. To obtain information about the buyer, the endpoint examines the takeover package to find the handover package. Since the handover package was signed by the revocation key of the manufacturer, the endpoint can quickly verify the validity of the request to switch operational keys. The handover package also contains the serial number and the recover public key of the endpoint that needs to be used for decrypting the keys to be used in the takeover. The handover package also contains the revocation public key of the buyer that would be used to verify the signature on the takeover package.

FIG. 4 shows that an unsigned takeover package 402 is configured to include the handover package 208 and the operational key bundle 308. The handover package 208 may have been generated according to the example of FIG. 2. The operational key bundle 308 may have been generated according to the example of FIG. 3. Additionally, the unsigned takeover package 402 may include data associated with package type 410, package version 412 and package length 414. A signing slot 416 may be provided.

An encryption scheme 404 and a revocation private key 406 of the utility may be used to sign the takeover package 402 and create a signed takeover package 408. The techniques 400 may be performed at the security manager 108 or other tool available to the utility or other buyer of the endpoint 104. Thus, the techniques 400 operate at facilities of the utility/buyer to bundle, encrypt and/or sign data for use in the switch of the endpoint from the use of device credentials of the manufacturer to the use of device credentials of the utility.

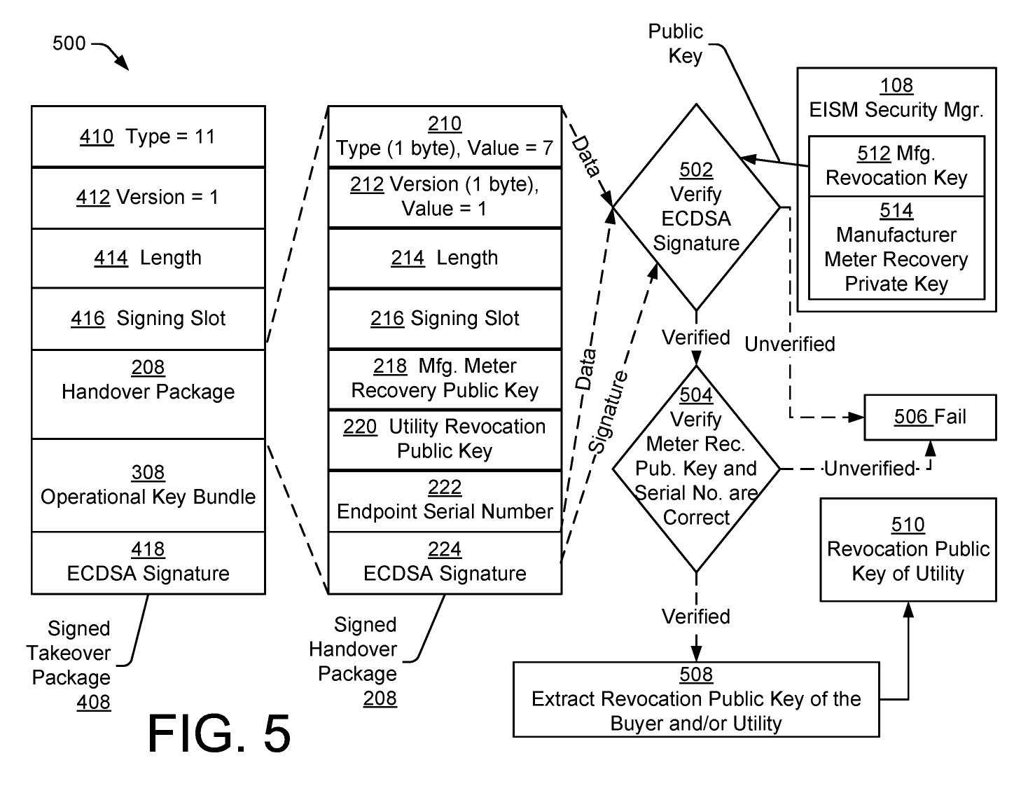

FIG. 5 is a block diagram showing example techniques 500 by which an endpoint may verify the signature 418 on the takeover package 408. The techniques 500 are an expansion of, or alternative variation of, the techniques of operation 136 in FIG. 1. The techniques 500 also describe example extraction of the utility revocation key 220 from the signed handover package 208.

At block 502, the ECDSA signature 224 is then verified on the entire takeover package 408 using the revocation public key 220 of the utility. The verification may be assisted by the manufacturer revocation key 512 and the manufacturer meter recovery key 514.

At procedure 504, verification of the meter recovery public key and endpoint serial number are performed. If either verification 502 or 504 fails, the failure is reported at 506, and the switchover from manufacturing device credentials to use of utility device credentials is prevented. However, if both verifications 502 and 504 are successful, a procedure 508 extracts the revocation public key 510 of the buyer.

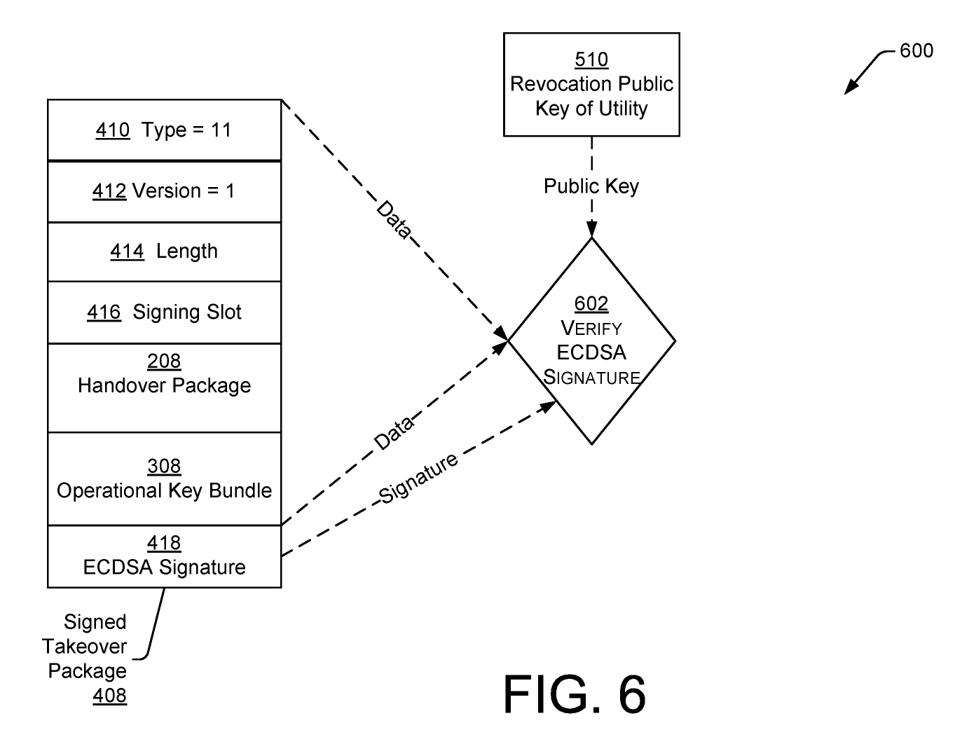

FIG. 6 shows example verification techniques 600 by which, after the entire takeover package is verified at 602 using ECDSA. The operational key bundle 308 may be extracted and decrypted using the ECIES algorithm. The techniques 600 are an expansion of, or alternative variation of, the techniques of operation 138 in FIG. 1.

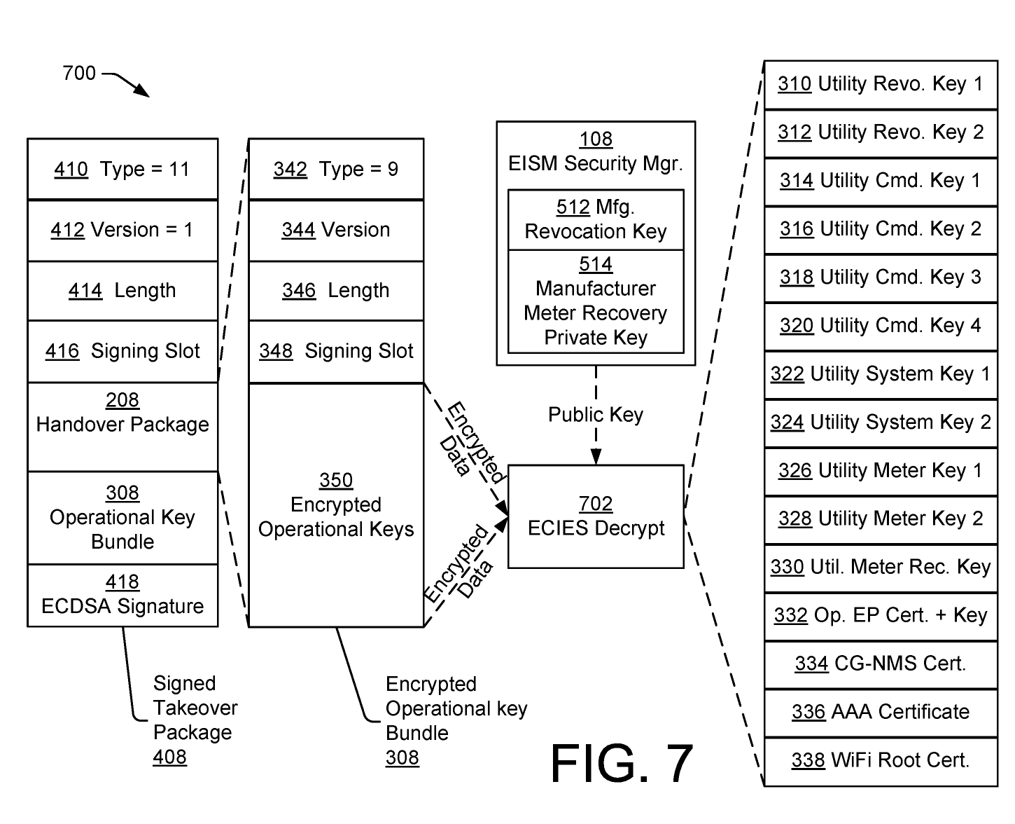

FIG. 7 shows an example relationship 700 of the signed takeover package 408, the encrypted operational key bundle 308 and the keys 310-338 extracted for use in the endpoint. The techniques 700 are an expansion of, or alternative variation of, the techniques of operation 140 in FIG. 1.

Once extracted, the operational keys can either replace the keys originally provided by the manufacture, or they can be put in a key store different from the key store containing the keys originally provided by the manufacture. The latter solution allows an easy method to move the endpoint into return merchandise authorization (RMA) mode.

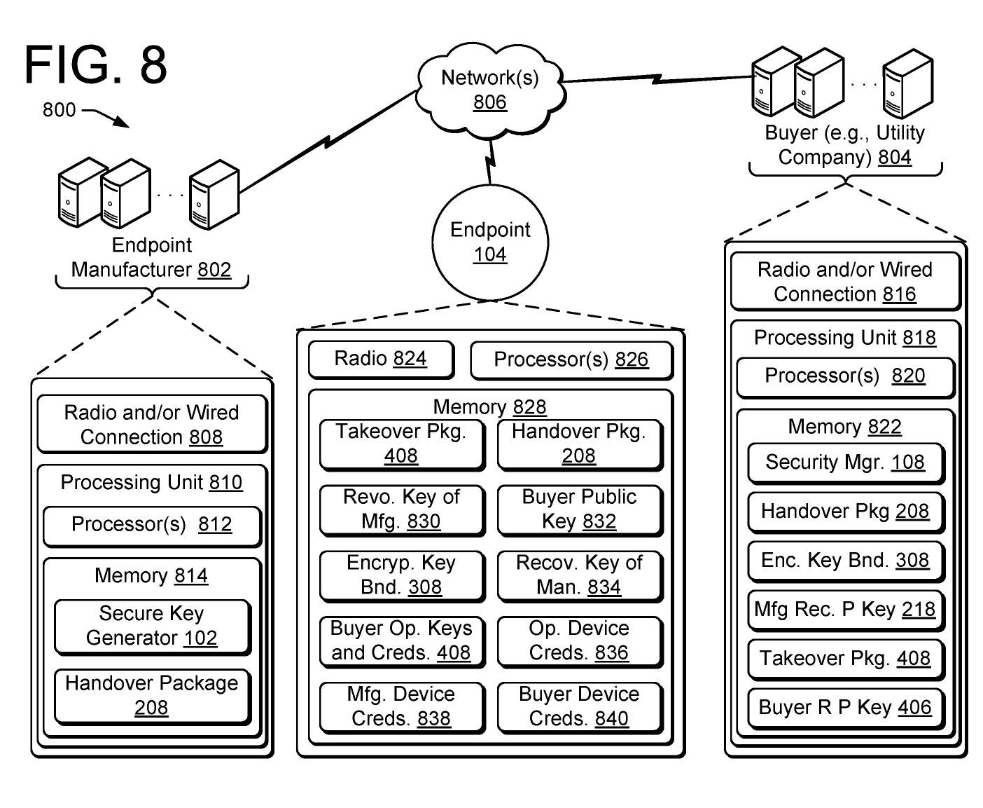

FIG. 8 shows an example environment 800 showing a relationship between an endpoint manufacturer 802, endpoint buyer 804 and an endpoint 104. In the relationship 800, the endpoint 104 switches from the use of device credentials 838 that were originally supplied by the manufacturer of the endpoint to the use of device credentials 840 subsequently supplied by the buyer 804 of the endpoint 104. Accordingly, the endpoint 104 is able to function in a secure manner under the direction of the buyer 804. Within the environment 800, the manufacturer 802, endpoint 104 and buyer 804, may communicate over a wired and/or wireless network 806.

The manufacturer 802 may have a radio 808 or wired connection to the network 806. The manufacturer 802 may have one or more computing devices, such as servers, mainframes and/or personal computers. These computing device(s) may have processing unit(s) 810 with one or more processors 812 and memory devices 814. The memory 814 may include an application or application package defining a secure key generator 102, an example of which was described with respect to FIG. 1. The memory 816 may also include the handover package 208, illustrated and/or discussed with respect to FIGS. 1, 2 and 4-7. In the example of FIG. 1, operation 124 created the handover package 208 and operation 126 transmitted the handover package to the buyer 804 over network 806.

In the example of FIG. 8, the buyer 804 of the endpoint 104 uses a radio 816 or wired connection to communicate with the network 806. The buyer 804 may have one or more computing devices, such as servers, mainframes and/or personal computers. These computing device(s) may have processing unit(s) 818 with one or more processors 820 and memory devices 822.

The memory 822 may include an application or application package defining a security manager 108, an example of which was described with respect to FIG. 1. The security manager 108 may be configured to receive a handover package 208 from the endpoint manufacturer 802.

The security manager 108 may be configured to create an encrypted operational key bundle 308 comprising keys that belong to the buyer 804. Such operational keys may include revocation key(s), command key(s), meter key(s), system key(s), a recovery key, meter certificate(s) and/or certificate chains.

The security manager 108 may encrypt the key bundle 308 using a recovery public key 218 of the manufacturer 802, which may be found in the handover package 208.

The security manager 108 may also create a takeover package 408 for transmission to the endpoint 104. The takeover package 408 may comprise signing the encrypted key bundle 308 and handover package 208 with a revocation private key of the buyer 406.

In the example of FIG. 8, the endpoint 104 may be a smart meter suitable for use in the utility industry, or may be a network-enabled device within the IoT. The endpoint 104 may use a radio 824 or wired connection to communicate over the network 806.

Operations performed by one or more processors 826 and using memory 828 may receive and manage the takeover package 408 from the security manager 108 of the buyer 804. The endpoint 104 then verifies the signature on the handover package 208, obtained from the takeover package 408, with the revocation key 830 of the manufacturer. The signature of the takeover package 408 is verified using the public key 832 of the buyer. The encrypted key bundle 308, also obtained from the takeover package 408, may then be decrypted using the recovery key 834 of the manufacturer 802. An example of this action was seen in FIG. 7. The operational keys and credentials 408 obtained from the buyer are stored as operational device credentials 836. The endpoint 104 then switches its operation from operation based on manufacturer-provided device keys and credentials 838 originally injected into the endpoint by the manufacturer 802, to operation based on buyer-provided device keys and credentials 840 based subsequently received in the takeover package from the buyer.

### Example Methods

In some examples of the techniques discusses herein, the methods of operation may be performed by one or more application specific integrated circuits (ASIC) or may be performed by a general purpose processor utilizing software defined in computer readable media such as memory devices. In the examples and techniques discussed herein, memory devices 814, 828 and/or 822 function within the secure key generator 102, the network endpoint 104 and/or the security manager 108, respectively. The memory may comprise computer-readable media and may take the form of volatile memory, such as random access memory (RAM) and/or non-volatile memory, such as read only memory (ROM) or flash RAM. Computer-readable media devices include volatile and non-volatile, removable and non-removable media implemented in any method or technology for storage of information such as computer-readable instructions, data structures, program modules, or other data for execution by one or more processors of a computing device. Examples of computer-readable media include, but are not limited to: phase change memory (PRAM), static random-access memory (SRAM); dynamic random-access memory (DRAM); other types of random access memory (RAM); read-only memory (ROM); electrically erasable programmable read-only memory (EEPROM); flash memory or other memory technology; compact disk read-only memory (CD-ROM); digital versatile disks (DVD) or other optical storage; magnetic cassettes; magnetic tape; magnetic disk storage or other magnetic storage devices; or any other non-transitory medium that can be used to store information for access by a computing device. As defined herein, computer-readable media does not include transitory media, such as modulated data signals and carrier waves, and/or signals.

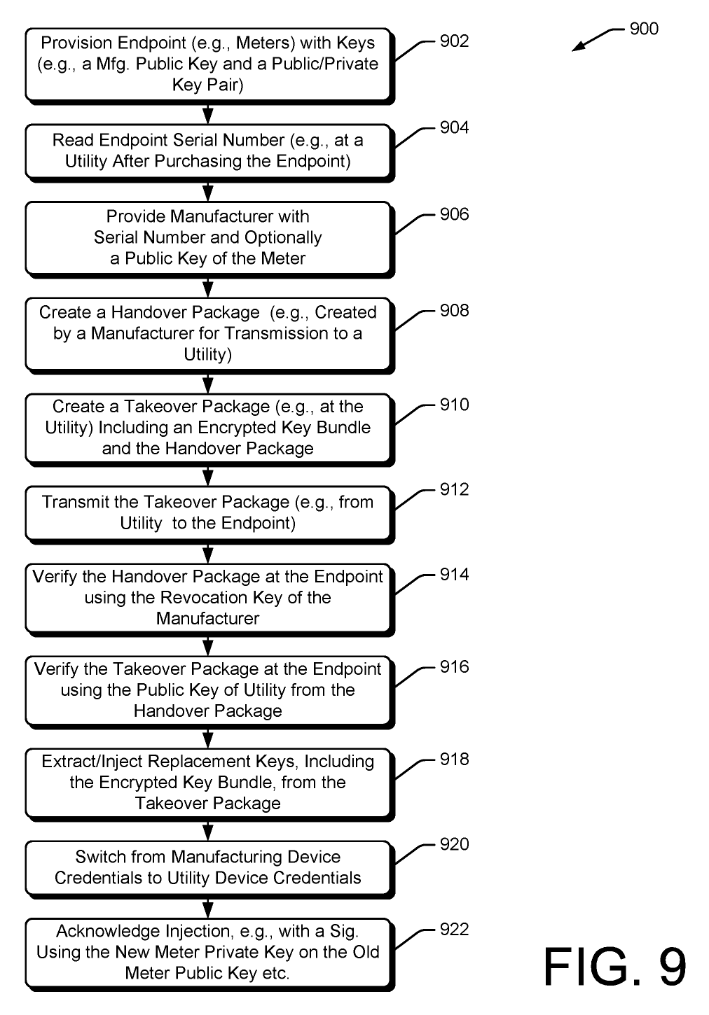

FIG. 9 shows an example method 900 of endpoint construction consistent with build-to-stock requirements, for application to an advanced metering infrastructure (AMI) or the Internet of Things. A plurality of blocks shown in FIG. 9 may correspond to objects, programs or applications defined in the memory of one or more devices.

At block 902, an endpoint is provisioned with cryptographic keys (e.g., a public key of a manufacturer of the endpoint and a public/private key pair). In the example of operation 110 shown in FIG. 1, the endpoint is provisioned with a number of keys and certificates.

At block 904, an endpoint serial number is read. In the example of an endpoint that is an electrical smart meter, the reading may be performed by a utility company after purchasing the meter. In the example of operation 118 of FIG. 1, the buyer of the endpoint reads the serial number as a part of receiving and setting up the incoming endpoint.

At block 906, the manufacturer is provided with the serial number and optionally with a public key of the meter. In the example of operation 122 of FIG. 1, the buyer of the endpoint provides information to the manufacturer, to thereby start the handover procedure.

At block 908, a handover package is created. In the example of operation 124 of FIG. 1, the handover package is created by a manufacturer for transmission to a buyer of an endpoint.

At block 910, a takeover package is created, and includes an encrypted key bundle and the handover package. In the example of operations 128, 130 and 132 of FIG. 1, a new key bundle for the endpoint is created, the bundle is encrypted, and the takeover package is signed, respectively.

At block 912, the takeover package is transmitted, such as from the buyer to the endpoint. In the example of operation 134 of FIG. 1, a buyer (e.g., a utility company) sends the takeover package to the endpoint (e.g., a smart meter).

At block 914, the handover package is verified at the endpoint. In the example of FIG. 1, at operation 136 the handover package is verified. The verification may be performed at the endpoint using the revocation key of the manufacturer.

At block 916, the takeover package is verified at the endpoint using the public key of the buyer, obtained from the handover package. In the example of FIG. 1, the takeover package is verified at operation 138.

At block 918, replacement keys are extracted and injected into the endpoint. The replacement keys may include keys from the encrypted key bundle from the takeover package. In the example of FIG. 1, the takeover package is verified at operation 142.

At block 920, the endpoint switches from operation based on manufacturer-provided device credentials to utility company- or buyer-provided device credentials. In the example of FIG. 1, the endpoint switches between original manufacturer-provided keys and credentials to new buyer-provided keys and credentials at operation 144.

At block 922, the endpoint acknowledges the injection of the keys. The acknowledgement may be performed in a number of ways, such as with a signature using the new meter private key on the old meter public key. An example of the acknowledgement is described at operation 146 of FIG. 1.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

1. A method to manufacture an endpoint, comprising:
provisioning the endpoint with keys at a manufacturer;
transferring the endpoint from the manufacturer to a site of a buyer;
creating a handover package at the manufacturer, wherein the creating comprises:
including a public key of the buyer in the handover package; and
including an identifier of the endpoint in the handover package;
signing the handover package with a private key of the manufacturer corresponding to a public key of the manufacturer within the endpoint;
specifying that the public key of the buyer is to be used to verify a takeover request; and
sending the handover package from the manufacturer to the buyer.

2. The method of claim 1, wherein the endpoint comprises a buyer meter.

3. The method of claim 1, wherein the provisioning of the endpoint with keys comprises:
injecting the endpoint with a manufacturer's public key; and
injecting the endpoint with a public/private key pair.

4. The method of claim 3, wherein injecting the endpoint with a public/private key pair comprises:
generating the public/private key pair on the endpoint prior to the injection.

5. The method of claim 1 wherein transferring the endpoint to the site of the buyer comprises:
sending the endpoint to the buyer by way of a reseller.

6. The method of claim 1, wherein creating the handover package additionally comprises:
including a revocation public key of the buyer.

7. The method of claim 1, wherein in the signing of the handover package with the private key of the manufacturer is a revocation private key of the manufacturer corresponding to a revocation public key of the manufacturer from among the keys provisioned in the endpoint.

8. The method of claim 1, wherein the sending of the handover package comprises signing the handover package in a secure key transfer file (SKTF) signed by a transfer key of the manufacturer.

9. A method to manage cryptographic keys on an endpoint, comprising:
reading an identifier of the endpoint;
providing a manufacturer of the endpoint with the serial number;
receiving a handover package from the manufacturer;
creating a takeover package, wherein the creating comprises:
creating a key bundle with operational keys of a buyer, wherein the key bundle is to replace keys within the endpoint;
encrypting the key bundle with a key found in the handover package; and
signing the encrypted key bundle and the handover package with a revocation private key of the buyer; and
transmitting the takeover package to the endpoint.

10. The method of claim 9, additionally comprising:
providing the manufacturer with a public key of the endpoint.

11. The method of claim 9, wherein the handover package received from the manufacturer comprises:
a revocation public key of the buyer;
the serial number of the endpoint; and
a recovery public key of the manufacturer.

12. The method of claim 9, wherein operational keys of the buyer comprise:
a revocation key of the buyer; and
a command key of the buyer.

13. The method of claim 9, wherein encrypting the key bundle with the key found in the handover package comprises:
encrypting the key bundle with a public recovery key of the manufacturer.

14. The method of claim 9, additionally comprising:
receiving, from the endpoint and responsive to the transmission of the takeover package to the endpoint, a message from the endpoint indicating that manufacturing device credentials previously used by the endpoint have been replaced by buyer device credentials currently used by the endpoint.

15. An endpoint, comprising:
a processor; and
memory, connected to the processor, wherein the memory defines objects comprising:
a handover package, received by the processor, defined in the memory, and verified using a public key of a manufacturer;
a takeover package, defined in the memory, and verified using a public key of a buyer of the endpoint obtained from the handover package;
replacement keys extracted from an encrypted bundle found in the takeover package;
manufacturer-provided keys and credentials initially installed in the endpoint;
buyer-provided device keys and credentials, wherein the buyer-provided device keys and credentials replace the manufacturer-provided keys and credentials and comprise the replacement keys; and
a confirmation message to indicate that the manufacturer-provided keys and credentials are no longer being used by the endpoint and that the buyer-provided keys and credentials are being used.

16. The endpoint of claim 15, wherein the handover package comprises:
a public key of the buyer;
an identifier of the endpoint; and
a public key of the manufacturer.

17. The endpoint of claim 15, wherein the public key of the manufacturer used to verify the handover package at the endpoint is a revocation key of the manufacturer.

18. The endpoint of claim 15 additionally comprising:
a certificate signing request (CSR); and
a certificate, obtained from a certificate authority of the buyer, in response to the CSR.

19. The endpoint of claim 15, wherein the buyer-provided device keys and credentials comprise:
command, revocation and recovery keys; and
a new public/private key pair.

20. The endpoint of claim 15, wherein the endpoint is configured to perform a Diffie Helman key exchange of symmetric keys and a secret, wherein the confirmation message additionally provides information to the buyer regarding the secret.
